(19) United States
(12) Patent Application Publication
(10) Pub. No.: US 2013/0285424 A1
(43) Pub. Date: Oct. 31, 2013

(54) SYSTEMS AND METHODS FOR CREATING A SEATING OR REMOVING SPACE IN A CHILD RESTRAINT SEAT

(71) Applicant: Mallory Jo Gardner, Cincinnati, OH (US)

(72) Inventor: Mallory Jo Gardner, Cincinnati, OH (US)

(21) Appl. No.: 13/456,040

(22) Filed: Apr. 25, 2012

(51) Int. Cl. A47D 1/00; B23P 11/00

(52) U.S. Cl. 297/250.1; 29/428

(57) ABSTRACT

A system for creating a seating or removing space in a child restraint seat, comprising: a child restraint seat comprising a chassis and at least one restraint; and at least one space creator; wherein the space creator comprises a first component and a second component, wherein the first component is attachable to the chassis, wherein the second component is attachable to the restraint, and wherein the space creator can be used to relocate the restraint in order to create a seating or removing space for a child. Further, a space-creator kit for creating a seating or removing space in a child restraint system. In addition, a method for creating a seating or removing space in a child restraint system.

### FIELD OF THE INVENTION

The present application relates generally to systems and methods for creating a seating or removing space in a child restraint seat so that a child may be easily and efficiently placed into and/or removed from the seat. More specifically, the present application relates to systems and methods for temporarily relocating the seat's restraints to create an open space into which a child may be placed or out of which a child may be removed.

### BACKGROUND OF THE INVENTION

Child restraint seats generally comprise at least one means to secure, or restrain, a child in the seat. Some child restraint seats, such as infant carriers and child vehicle seats, comprise multiple restraints. For example, these seats typically comprise a chest clip near a child's chest and armpits, a buckle assembly near the child's thighs, and a harness adjuster near a front bottom edge of the child restraint seat chassis. Straps may connect to each of these; for instance, shoulder straps may connect to the chest clip and/or the buckle assembly; waist straps may connect to the buckle assembly; a short buckle strap may connect the buckle assembly to the child restraint seat chassis; and a long harness adjustment strap may run behind the child restraint seat chassis, connecting the shoulder straps and waist straps and protruding from the harness adjuster. The shoulder straps and waist straps may be tightened via pulling the harness adjustment strap.

While the safety benefits of restraint systems in child restraint chairs are apparent, all of the moving parts may create problems for caregivers trying to strap a child into a child restraint seat. Problems may arise with child restraint seats which have only a few moving parts, such as a booster seat or stroller having a simple lap belt, as well as with child restraint seats having many moving parts, such as the infant carrier or child vehicle seats described above, having a 3-point or 5-point restraint system. Before use of a child restraint seat, the restraints wait, dormant and unfettered, right in the area where a child is to be placed. Typically, a caregiver will spread apart the restraints in order to make room to place a child in the seat. Often this is harder than it sounds. Frequently, a caregiver holds a child while trying to spread apart the restraints with one hand. Or, a caregiver may leave a child momentarily unattended while attempting to create an open area free of restraints. Unfortunately, the restraints generally don't stay in this caregiver-created open position for long. Rather, the restraints start slipping back to the original dormant position, which is generally where the child is to be placed. As a child is placed into the child restraint seat, it is even more likely that the restraints will fall back to their original dormant position if the seat is bumped, jiggled, or the like by the caregiver or child while the child is being placed into the seat. It is cumbersome to place a child into a child restraint seat and then have to fish out the restraints from behind or underneath the child in order to secure the child in the seat. This problem is compounded when trying to place a sleeping child into a child restraint seat, for tugging the restraints out from under the child may wake them. These problems may also occur when trying to remove a child from a child restraint seat. For instance, it is also difficult for a caregiver to remove a sleeping child from a child restraint seat after unfettering the restraints, since the unfettered restraints may become tangled or stuck to the child's limbs. Relatedly, it can be hard to buckle a child into or remove child from a child vehicle seat while standing outside of a car; it can be hard to locate or reach all of the necessary restraints, particularly those on the side of the seat near the middle of the car.

To address these issues (and others), child restraint seat manufacturers and sellers have begun to create “travel systems” whereby a specialized infant carrier seat is able to snap into a stroller, caddy, or stay-in-car base. This system attempts to address the need to relocate a sleeping baby without waking them up. However, these systems can be very expensive (e.g., GRACO Stylus' Travel System has an MSRP of $219.99, CHICCO Cortina KeyFit® 30 Travel System has an MSRP of $349.99, and CHICCO Multi KeyFit® Caddy™ Car Seat Carrier has an MSRP of $99.99). Many caregivers already have car seats, strollers, and the like, and can't justify purchasing a whole new set. Further, while it is helpful to be able to transport a child from a stroller to a car, there are times when the caregiver needs to remove the child from the child restraint seat (e.g., to place into a crib to continue sleeping, to change a diaper, etc.). So, these travel systems still do not address the need to remove a sleeping child from a child restraint seat.

There exists a need for a child restraint seat that comprises an integral means for creating and utilizing space in the child restraint seat so that a child may be easily and efficiently placed into and/or removed from the seat. There also exists a need for an inexpensive “fix” to use with child restraint seats already marketed, purchased, or in use. More specifically, there is a need to temporarily relocate the restraints in a child restraint seat to create an open space into which a child may be placed or out of which a child may be removed.

### SUMMARY OF THE INVENTION

A system for creating a seating or removing space in a child restraint seat, comprising: a child restraint seat comprising a chassis and at least one restraint; and at least one space creator; wherein the space creator comprises a first component and a second component, wherein the first component is attachable to the chassis, wherein the second component is attachable to the restraint, and wherein the space creator can be used to relocate the restraint in order to create a seating or removing space for a child.

A space-creator kit for creating a seating or removing space in a child restraint system, comprising at least one space creator, the space creator comprising: a first component attachable to a child-restraint-seat chassis; and a second component attachable to a child-restraint-seat restraint, and wherein the space creator can be used to relocate the restraint in order to create a seating space for a child.

A method for creating a seating or removing space in a child restraint system, comprising: providing a child restraint seat, comprising: 1) chassis; and 2) at least one restraint selected from the group consisting of a belt, strap, clip, buckle, buckle assembly, tether, latch, harness, harness adjuster, harness adjuster strap, or the like, and combinations thereof; providing a space creator, comprising: 1) a first component attachable to the chassis; and 2) a second component attachable to the restraint; and mating the first component with the second component to relocate the restraint and create a seating or removing space for a child.

### BRIEF DESCRIPTION OF THE DRAWINGS

Both the foregoing general description and the following detailed description describe various systems and methods and are intended to provide an overview or framework for understanding the nature and character of the claimed subject matter. The accompanying drawings are included to provide a further understanding of the various systems and methods, and are incorporated into and constitute a part of this specification. The drawings illustrate various systems and methods described herein, and together with the description serve to explain the principles and operations of the claimed subject matter.

FIG. 1 depicts a traditional child restraint seat as described herein;

FIG. 2 depicts a child restraint seat comprising exemplary space-creators described herein, wherein the restraints are unfastened and dormant;

FIG. 3 depicts a child restraint seat comprising additional exemplary space-creators described herein, wherein the restraints are fastened and dormant; and

FIG. 4 depicts a child restraint seat comprising further exemplary space-creators described herein, wherein the restraints are unfastened and relocated via the space creators to create a seating or removing space.

### DETAILED DESCRIPTION OF THE INVENTION

As used herein, the phrase “restraint” or “restraints” means a belt (e.g., a lap belt), strap (e.g., shoulder strap, waist strap), clip (e.g., chest clip), buckle, buckle assembly, tether, latch, harness, harness adjuster, harness adjuster strap, or the like, and combinations thereof.

As used herein, the phrase “child restraint seat” or “child seat” means a seat for restraining a child. This seat may be a booster chair, a bouncer, an infant carrier, a child vehicle seat (including a car seat), a high chair, a stroller, a swing, a walker, or the like, and combinations thereof, wherein the seat comprises at least one form of restraint.

As used herein, the word “relocate” means to place in a different location, holdback, restrain, secure, move out of the way (“way” being the place where the child contacts the seat), tether, tie-back, or the like.

As used herein, the words “create,” “make,” “provide,” and “open,” may be used interchangeably when referring to creating seating space, making seating space, providing seating space, opening up seating space, and the like.

As used herein, the word “attach” means to fasten, join, or affix a component to a portion of a child restraint seat.

The systems and methods described herein may be used to create and utilize space in a child restraint seat so that a child may be easily and efficiently placed into and/or removed from the seat. The present application relates to systems and methods for temporarily relocating the seat's restraints to create an open space into which a child may be placed or out of which a child may be removed. This goal may be achieved by relocating the restraints with a system integral to the child restraint seat or with an inexpensive “fix” to use with child restraint seats already marketed, purchased, or in use.

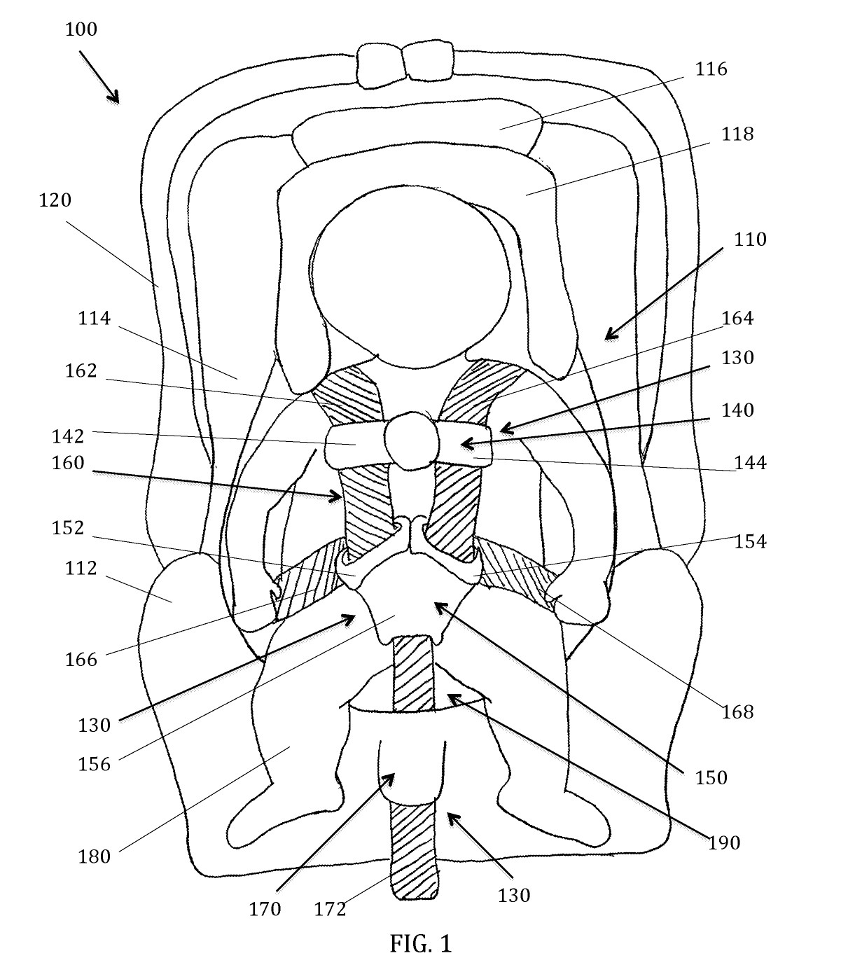

FIG. 1 shows a traditional child restraint seat 100 in the form of an infant carrier. The seat comprises a chassis 110 and a positionable handle 120. The chassis 110 comprises a chassis body 112, cushion 114, a headrest 116, and a removable infant insert 118. The seat further comprises restraints 130, including a chest clip (aka harness retainer) 140, a buckle assembly 150, a harness 160, and a harness release lever (or harness adjuster) 170. The chest clip 140 comprises a female member 142 and a male member 144 that releasably engage to lock the chest chip 140. The buckle assembly 150 comprises a pair of buckle plates/latches 152, 154 that releasably engage with the buckle 156 to lock the buckle assembly 150. The harness 160 includes a pair of shoulder straps 162, 164 that extend from the chassis 110, through the chest clip 140, and connect to the buckle plates 152, 154. The harness 160 also includes a pair of waist straps 166, 168 that extend from the chassis 110 and connect to the buckle plates 162, 164. The waist straps 166, 168 can be completely separate from the shoulder straps 162, 164, or, the waist straps 166, 168 may connect at the buckle plates 152, 154. The harness 160 further includes a harness adjustment strap 172 that connects to the buckle 156 and is thread through the harness release lever 170 (which may be hidden by a harness release flap of material). A child 180 sits in a seating or removing space 190. It is easy to see how the restraints 130, once unfastened, can get in the way of removing the child 180 from the seat 100.

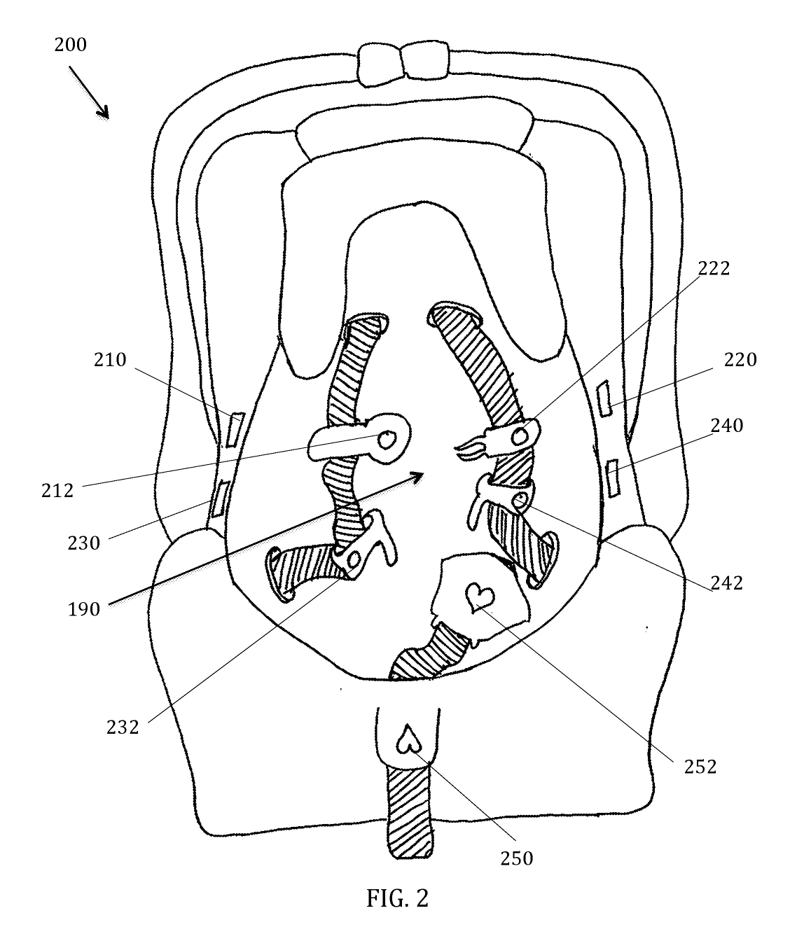

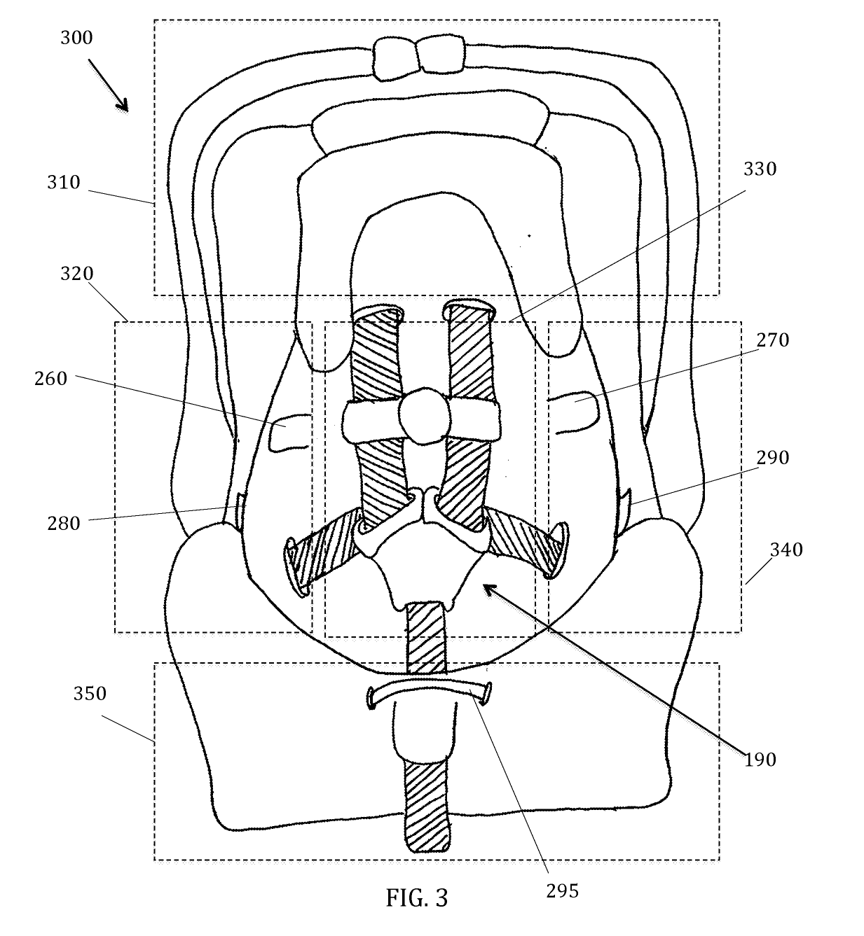

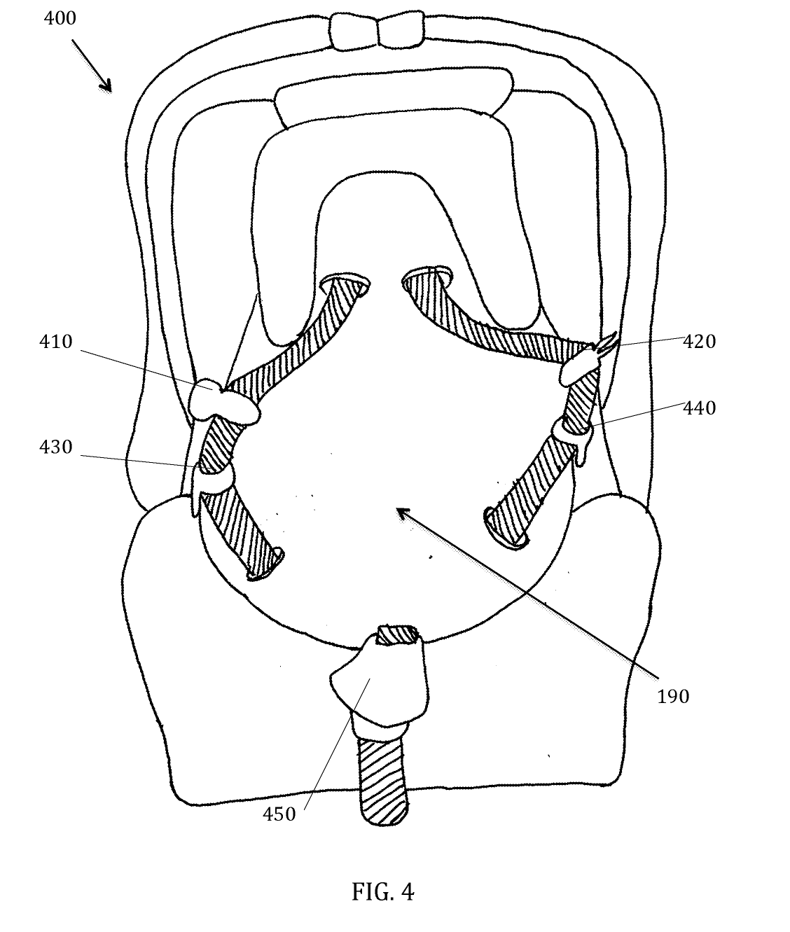

FIGS. 2, 3, and 4 depict child restraint seats 200, 300, 400 similar to the seat 100 of FIG. 1 wherein no child is occupying the seats. The item numbering from FIG. 1 carries over to these figures. In FIG. 2, the restraints are unbuckled and dormant and lie in the seating or removing space 190. In FIG. 3, the restraints are buckled but dormant, yet still lie in the seating or removing space 190. In FIG. 4, the restraints are unbuckled and secured out of the way of the seating or removing space 190 via space creators. It is easy to see how these restraints can get in the way of placing a child into the seat. The systems, kits, and methods described herein relate to the need to temporarily relocate the restraints in a child restraint seat to create an open space into which a child may be placed or out of which a child may be removed.

The present inventions cover integral, semi-integral, and non-integral means for creating a seating and/or removing space in a child restraint seat so that a child may be easily and efficiently placed into and/or removed from the seat. Accordingly, this invention may apply to child restraint seats manufactured and sold with the space creators described herein; the space creators may be manufactured as an integral part of the child restraint seat, or, the space creators may be manufactured separately (i.e., non-integral) from the child restraint seat yet packaged with or included as a component of the child restraint seat. Or, the space creators may be manufactured, packaged, and sold separately from child restraint seats. This option provides consumers with an inexpensive “fix” to use with child restraint seats already marketed, purchased, or in use.

Referring back to the drawings, FIGS. 2-4 show exemplary systems for creating a seating or removing space 190 in a child restraint seat 200, 300, 400, comprising a chassis, an optional cushion, at least one restraint, and at least one space creator. The space creator comprises a first component and a second component. The first components 210, 220, 230, 240, 250, 260, 270, 280, 290, 295 are attachable to the chassis. The second components 212, 222, 232, 242, 252 are attachable to the restraint. The space creators 410, 420, 430, 440, 450 can be used to relocate the restraint in order to create a seating or removing space 190 for a child. It is common for a child restraint seat to have more than one variety of restraint for restraining a child. FIGS. 2-4 show seats exemplifying various restraints and various space creators.

There may be a space creator for each distinct restraint. However, it is not always necessary to have a space creator for each restraint. Rather, it is helpful to have a space creator for each restraint that gets in the way of the seating or removing space. For instance, a shoulder strap or a waist strap may cause trouble for a user because they are long enough to intrude into the seating or removing space. But, a shorter strap may not cause such a problem and thus may not need an associated space creator.

As shown in FIG. 3, the chassis includes five zones: a first zone 310 located near the top (comprising, e.g., a headrest, a pillow), a second zone 320 located near the middle-left, a third zone 330 located in the middle of the seat (comprising, e.g., restraints, the seating area), a fourth zone 340 located near the middle-right, and a fifth zone 350 located near the bottom.

The space-creator first component 210, 220, 230, 240, 250, 260, 270, 280, 290, 295 is not located in the first zone or the third zone. The first component is located in at least one of the following three zones: the second zone, the fourth zone, or the fifth zone. Within the second and fourth zones, the first component may be present in various locations, such as the chassis body, a cushion, an infant insert, a harness strap cover, or a side pad. Within the fifth zone, the first component may be present on or near a harness release lever, a harness release lever flap, the chassis body, or a cushion. In one embodiment, the first components are located in each of the second, fourth, and fifth zones. For instance, the first components may be located on the chassis body and/or cushion in the second and fourth zones, and the harness release lever, strap, or flap in the fifth zone.

The space-creator second component 212, 222, 232, 242, 252 is located on at least one restraint. For instance, second components may be located on a chest clip female member, a chest clip male member, a first shoulder strap, a second shoulder strap, a first buckle plate/latch, a second buckle plate/latch, a first waist strap, a second waist strap, a buckle, or combinations thereof. The second component may be located on at least two restraints, at least three restraints, or at least four restraints. In one embodiment, the second components are located on the chest clip female member and the chest clip male member. In another embodiment, the second component is located on the buckle.

The first component is matable with the second component to relocate the restraint and create a seating or removing space for a child. The first component and second component may be paired with complementary relocating mechanisms such that the first component and second component releasably engage, or mate. The restraint is preferably relocated out of the chassis third (middle) zone to make space to insert or remove a child into/from the child restraint seat. The space-creator first component comprises a relocating mechanism selected from the group consisting of a snap, a button, a magnet, a buckle, Velcro, an elastic loop tether (e.g., attached to the chassis body, cushion, or side pad), an adhesive, a hole, an alcove, a slot, a pocket, a flap, a depression, a protrusion, and combinations thereof. The space-creator second component comprises a relocating mechanism selected from the group consisting of a snap, a button, a magnet, a buckle, Velcro, a bobble (e.g., a little plush toy or a ball attached to the buckle), an adhesive, a depression, a protrusion, the restraint itself, and combinations thereof. In some embodiments, the first component and second component may comprise the same type of relocating mechanism, such as snap-snap, magnet-magnet, Velcro-Velcro, or adhesive-adhesive (e.g., wherein the adhesive only sticks to itself, not to other items). In other embodiments, the first component and second component may comprise different types of relocating mechanisms, such as 1) an elastic loop tether and a bobble, such that the bobble on the restraint may be tethered out-of-the-way of the seating space to the elastic loop tether on the chassis; 2) a pocket or slot and a restraint (e.g., a male chest clip member), such that the male chest clip member is able to be inserted/stored/hidden in the pocket/slot on the chassis which is located outside the seating space; or 3) a depression on the chassis and a protrusion on the restraint such that the restraint temporarily snap-fits to the chassis in a preferred location which is out of the way of the seating space. One example of combination relocating mechanisms is where the first component is in the form of a magnet or piece of Velcro located on the underside of the harness release flap. In use, the buckle restraint may have a corresponding magnet or piece of Velcro such that the flap may be flipped up and the buckle may be flipped down so that the two parts engage to relocate the buckle from the seating area.

While the first and second components of the space creator are frequently referred to herein as attached or attachable to the child restraint seat, it should be understood that the first and/or second components may additionally or alternatively be designed integrally with the child restraint seat. Thus, saying that the first component is attached to the chassis, or that the second component is attached to the restraint, is intended to cover situations in which the components are manufactured integral with the chassis or restraint.

As mentioned earlier, the space creators may be integral with, semi-integral, or non-integral with the child restraint seat. The space creator may be initially integral with the seat, such that the first component is attached to the chassis and the second component is attached to the restraint. Or, the space creator is initially not integral with the seat, such that a user must attach the first component to the chassis and the second component to the restraint. Or, the space creator is initially semi-integral with the seat, such that the either first component is attached to the chassis or the second component is attached to the restraint and a user must attach the non-attached component to the chassis or restraint.

When the space creator is initially not integral with the seat, it may be sold as a space-creator kit for creating a seating or removing space in a child restraint system. Accordingly, a kit may comprise a first component attachable to a chassis and a second component attachable to a restraint. A user may attach the first component and second component to the chassis and restraint. The space creator is used to relocate the restraint in order to create or expand a seating or removing space for a child. It is envisioned that multiple space-creators may be used on one child restraint seat. This is because child restraint seats often comprise more than one restraint. Preferably, a space-creator kit comprises a second space creator. The second space creator comprises a first component attachable to the seat chassis and a second component attachable to a second restraint on the seat. In one exemplary embodiment, the child restraint seat comprises a first restraint in the form of a buckle assembly and a second restraint in the form of a clip. The appropriate kit for this embodiment comprises at least two space-creators.

In addition, the present inventions comprise a method for creating a seating or removing space in a child restraint system. The method comprises providing a child restraint seat, comprising a chassis and at least one restraint; providing a space creator, comprising a first component attachable to the chassis and a second component attachable to the restraint; and mating the first component with the second component to relocate the restraint and create a seating or removing space for a child. Also, the method comprises placing a child into or removing a child from the seating or removing space. Often, the method further comprises providing a second restraint and a second space creator, the second space creator comprising: a first component attachable to the chassis and a second component attachable to the second restraint.

While particular systems and methods of the present invention are illustrated and described herein, those skilled in the art will appreciate that various other changes and modifications may be made without departing from the spirit and scope of this invention. The following claims should be read to include such changes and modifications that are within the scope of this invention.

What is claimed is:

1. A system for creating a seating or removing space in a child restraint seat, comprising:
a child restraint seat comprising a chassis and at least one restraint; and
at least one space creator;
wherein the space creator comprises a first component and a second component, wherein the first component is attachable to the chassis, wherein the second component is attachable to the restraint, and wherein the space creator can be used to relocate the restraint in order to create a seating or removing space for a child.

2. The system of claim 1, wherein the child restraint seat is selected from the group consisting of a booster chair, a bouncer, an infant carrier, a child vehicle seat, a high chair, a stroller, a swing, a walker, or the like, and combinations thereof.

3. The system of claim 1, wherein the restraint is selected from the group consisting of a belt, strap, clip, buckle, buckle assembly, tether, latch, harness, harness adjuster, harness adjuster strap, or the like, and combinations thereof.

4. The system of claim 1, wherein the first component is attached to the chassis.

5. The system of claim 1, wherein the chassis comprises a cushion, and wherein the first component is attached to the cushion.

6. The system of claim 1, wherein the second component is attached to the restraint.

7. The system of claim 1, wherein the seat comprises at least two restraints and at least two space creators.

8. The system of claim 7, wherein the restraints comprise at least a clip and a buckle assembly.

9. The system of claim 1, wherein the first component and second component each comprise a relocating mechanism selected from the group consisting of a snap, a button, a magnet, a buckle, Velcro, an elastic loop tether, an adhesive, a hole, an alcove, a slot, a pocket, a flap, a depression, a protrusion, a bobble, the restraint itself, and combinations thereof.

10. The system of claim 1, wherein the space creator is initially integral with the seat, such that the first component is attached to the chassis and the second component is attached to the restraint.

11. The system of claim 1, wherein the space creator is initially not integral with the seat, such that a user must attach the first component to the chassis and the second component to the restraint.

12. The system of claim 1, wherein the space creator is initially semi-integral with the seat, such that the either first component is attached to the chassis or the second component is attached to the restraint and a user must attach the non-attached component to the chassis or restraint.

13. A space-creator kit for creating a seating or removing space in a child restraint system, comprising at least one space creator, the space creator comprising:
a) a first component attachable to a child-restraint-seat chassis; and
b) a second component attachable to a child-restraint-seat restraint, and wherein the space creator can be used to relocate the restraint in order to create a seating or removing space for a child.

14. The kit of claim 13, further comprising a second restraint and a second space creator, the second space creator comprising:
a) a first component attachable to the chassis; and
b) a second component attachable to the second restraint;
wherein the first restraint is a buckle assembly; and
wherein the second restraint is a clip.

15. The kit of claim 13, wherein the first component and second component each comprise a relocating mechanism selected from the group consisting of a snap, a button, a magnet, a buckle, Velcro, an elastic loop tether, an adhesive, a hole, an alcove, a slot, a pocket, a flap, a depression, a protrusion, a bobble, the restraint itself, and combinations thereof.

16. A method for creating a seating or removing space in a child restraint system, comprising:
a) providing a child restraint seat, comprising:
1) a chassis; and
2) at least one restraint selected from the group consisting of a belt, strap, clip, buckle, buckle assembly, tether, latch, harness, harness adjuster, harness adjuster strap, or the like, and combinations thereof;
b) providing a space creator, comprising:
1) a first component attachable to the chassis; and
2) a second component attachable to the restraint; and
c) mating the first component with the second component to relocate the restraint and create a seating or removing space for a child.

17. The method of claim 16, further comprising placing a child into or removing the child from the seating or removing space.

18. The method of claim 16, further comprising providing a second restraint and a second space creator, the second space creator comprising:
a) a first component attachable to the chassis; and
b) a second component attachable to the second restraint;
wherein the second restraint is selected from the group consisting of a belt, strap, clip, buckle, buckle assembly, tether, latch, harness, harness adjuster, harness adjuster strap, or the like, and combinations thereof.

19. The method of claim 16, wherein the first component comprises a relocating mechanism selected from the group consisting of a snap, a button, a magnet, a buckle, Velcro, an elastic loop tether, an adhesive, a hole, an alcove, a slot, a pocket, a flap, a depression, a protrusion, and combinations thereof.

20. The method of claim 16, wherein the second component comprises a relocating mechanism selected from the group consisting of a snap, a button, a magnet, a buckle, Velcro, a bobble, an adhesive, a depression, a protrusion, the restraint itself, and combinations thereof.
